(19) United States
(12) Patent Application Publication
(10) Pub. No.: US 2007/0130835 A1
(43) Pub. Date: Jun. 14, 2007

(54) Apparatus for moving window glass of vehicle

(75) Inventors: Yukio Isomura, Chita-shi (JP); Shigeyuki Suzuki, Kariya-shi (JP); Yoshihiro Shimizu, Kariya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: AISIN SEIKI KABUSHIKI KAISHA

(21) Appl. No.: 11/636,457

(22) Filed: Dec. 11, 2006

(30) Foreign Application Priority Data
Dec. 14, 2005 (JP) 2005-360552

(51) Int. Cl. E05F 11/48

(52) U.S. Cl. 49/352

(57) ABSTRACT

An apparatus for moving a window glass of a vehicle includes a carrier fixed to a window glass, a guiding rail for slidably supporting the carrier, a driven member fixed to the carrier and an actuator for driving the driven member. The actuator includes a cylinder-shaped rotational driving member for driving the driven member, a holder provided at an outside of the rotational driving member and having an arc-shaped inner surface facing an outer circumferential surface of the rotational driving member and coaxial with the rotational driving member and an arc-shaped moving member having a circumferential length longer than that of the inner surface of the holder, the moving member being provided between the rotational driving member and the inner surface of the holder for circumferential movement by the driven member.

### CROSS REFERENCE TO RELATED APPLICATIONS

This application is based on and claims priority under 35 U.S.C. § 119 to Japanese Patent Application 2005-360552, filed on Dec. 14, 2005, the entire content of which is incorporated herein by reference.

### FIELD OF THE INVENTION

This invention generally relates to an apparatus for moving a window glass of a vehicle.

### BACKGROUND

Conventionally, an apparatus for moving a window glass of a vehicle (window regulator) is provided at a vehicle such as an automobile. The apparatus includes a driving portion such as a motor. The apparatus moves a window glass up and down. As described in, for example, JPH4 (1992)-13783U, such a window regulator drives a driven member such as a wire by a rotor of a cylindrical shape, moves a carrier fixed to the driven member along a guiding rail attached to a vehicle door and moves a window glass fixed to the carrier up and down.

However, in the window regulator configured as described above, because a movement of the carrier is impeded by sliding resistance between the carrier and the guiding rail or because the movement of the carrier is impeded at an entirely opened position or at an entirely closed position of the window glass, tensile load is applied to the driven member between the carrier and an output gear. Accordingly, there is a hazard that the driven member may be elongated by the tensile load. Further, in the window regulator configured as described above, because the driven member is fit to a linear wire-fitting portion formed at the carrier, there can be a situation where the tensile load applied to the driven member gives adverse effect to engagement between the driven member and the carrier. Because of these reasons above, there can be a situation where the window regulator cannot be used over a long term.

A need thus exists for an apparatus for moving a window glass of a vehicle that can preferably operate in a long term. The present invention has been made in view of the above circumstances and provides such an apparatus for moving a window glass of a vehicle.

### SUMMARY OF THE INVENTION

According to an aspect of the present invention, an apparatus for moving a window glass of a vehicle includes a carrier fixed to a window glass, a guiding rail for slidably supporting the carrier, a driven member fixed to the carrier and an actuator for driving the driven member to move the window glass along the guiding rail. The actuator includes a rotational driving member formed in a cylindrical shape and rotated for driving the driven member, a holder provided at an outside of the rotational driving member in a diametrical direction and having an inner surface facing an outer circumferential surface of the rotational driving member, the inner surface being an arc shape coaxial with the rotational driving member, and an arc-shaped moving member having a circumferential length longer than a circumferential length of the inner surface of the holder, the moving member being provided between the rotational driving member and the inner surface of the holder for circumferential movement by the driven member.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a schematic view illustrating a configuration of an apparatus for moving a window glass of a vehicle according to an embodiment of the present invention;

FIG. 2 represents a side view illustrating a part of the apparatus for moving the window glass of the vehicle;

FIG. 3 represents a cross-sectional view taken on line III-III of FIG. 1;

FIG. 4 represents a schematic view illustrating a configuration of a part of the apparatus for moving the window glass of the vehicle;

FIG. 5 represents a schematic view illustrating a configuration of a part of the apparatus for moving the window glass of the vehicle;

FIG. 6 represents a schematic view illustrating a configuration of a part of the apparatus for moving the window glass of the vehicle;

FIG. 7 represents an explanatory diagram for explaining an operation of the apparatus for moving the window glass of the vehicle;

FIG. 8 represents an explanatory diagram for explaining an operation of the apparatus for moving the window glass of the vehicle;

FIGS. 9A to 9D represent explanatory diagrams for explaining an operation of the apparatus for moving the window glass of the vehicle;

FIG. 10 represents an explanatory diagram for explaining an effect of the apparatus for moving the window glass of the vehicle according to the embodiment of the present invention;

FIG. 11 represents an explanatory diagram for explaining an effect of the apparatus for moving the window glass of the vehicle according to the embodiment of the present invention;

FIG. 12 represents an explanatory diagram for explaining an effect of the apparatus for moving the window glass of the vehicle according to the embodiment of the present invention; and

FIG. 13 represents a schematic view illustrating a configuration of another example of the apparatus for moving the window glass of the vehicle according to the embodiment of the present invention.

### DETAILED DESCRIPTION

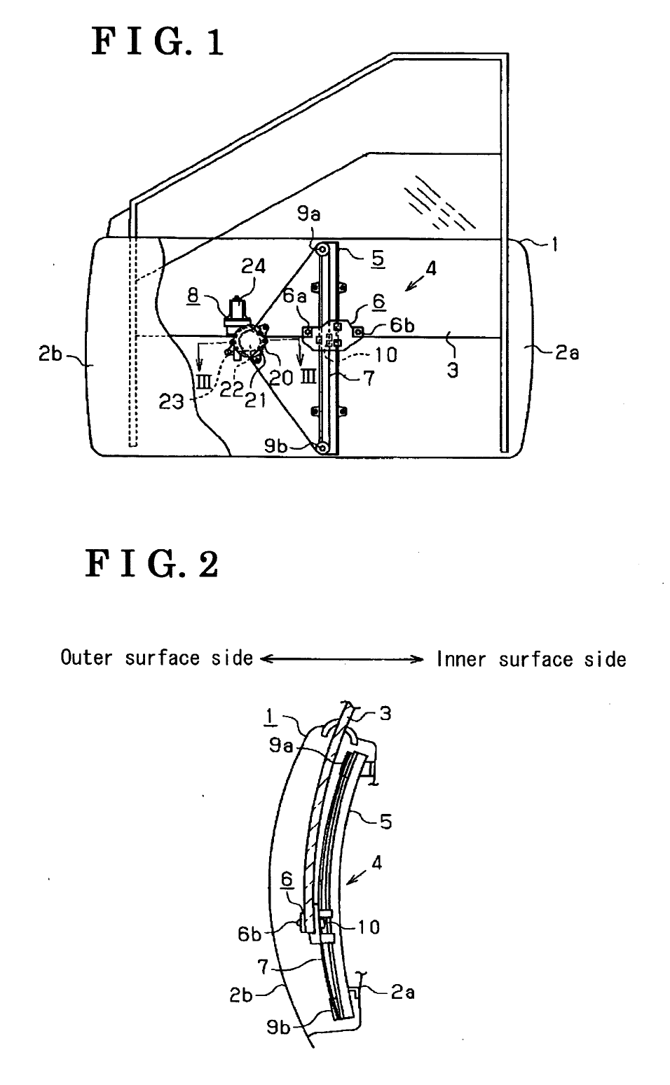

An embodiment of the present invention will be explained with reference to drawing figures. As illustrated in FIG. 1, a side door 1, which configures a body of a vehicle and serves as a vehicle door, is configured from an inner panel 2a provided at an inner surface side of the vehicle and an outer panel 2b provided at an outer surface side. A window regulator 4 for moving a window glass 3 up and down is provided in a space surrounded by the inner panel 2a and the outer panel 2b, which configure the side door 1.

A guiding rail 5 of the window regulator 4 is provided in the space surrounded by the inner panel 2a and the outer panel 2b and extends along a vertical direction. A carrier 6 is slidably supported by the guiding rail 5. A belt 7 (for example, a timing belt 7 made of resin), which serves as a driven member (operating member), is fixed to the carrier 6. The timing belt 7, which serves as the belt 7, is driven by an actuator 8.

In a side view illustrated in FIG. 2, the guiding rail 5 is formed to curve so as to curve out toward the outer surface side of the side door 1 corresponding to a curvature of the window glass 3. The guiding rail 5 is fixed to the inner panel 2a. Shafts of pulleys 9a and 9b are fixed to upper and lower ends of the outer surface side of the guiding rail 5. The timing belt 7 is strapped along the pulleys 9a and 9b and the actuator 8.

The carrier 6 is formed to have a plate shape. The carrier 6 is slidably supported by the guiding rail 5 at the outer surface side. Further, a lower end portion of the window glass 3 is fixed to the carrier 6 by bolts 6a and 6b (refer to FIG. 1).

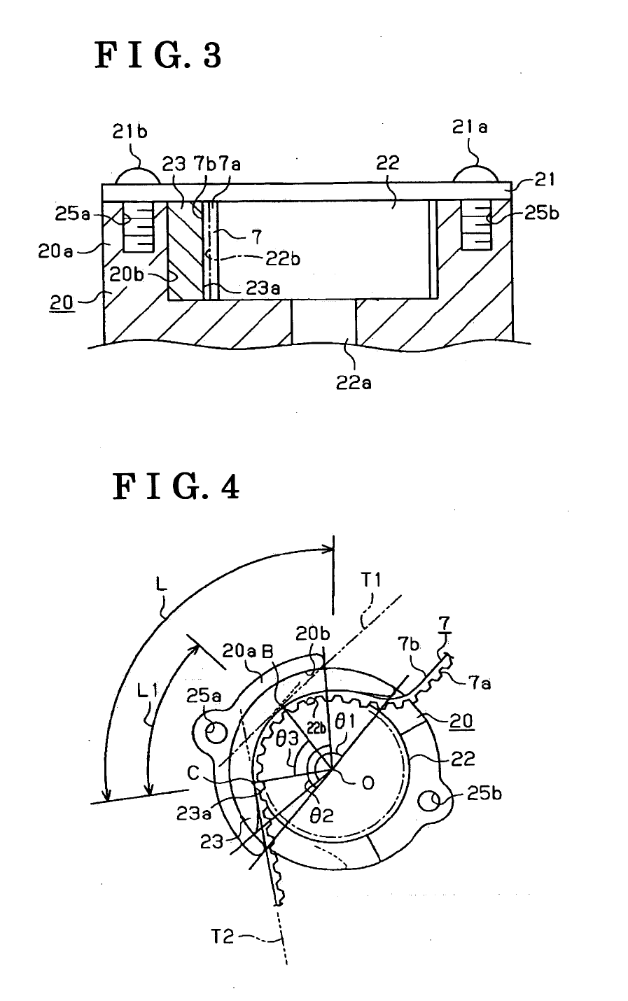

The timing belt 7 is formed so as not to have an end. As illustrated in FIGS. 3 and 4, a teeth portion 7a, which serves as an engaging portion, is formed at an inner side (inner circumferential side) of the timing belt 7. The teeth portion 7a is formed from a material superior in wear resistance to that of a back surface 7b because the teeth portion 7a contacts the actuator 8 and the pulleys 9a and 9b. Further, the timing belt 7 is fixed to a belt-fixing portion 10 provided at the carrier 6.

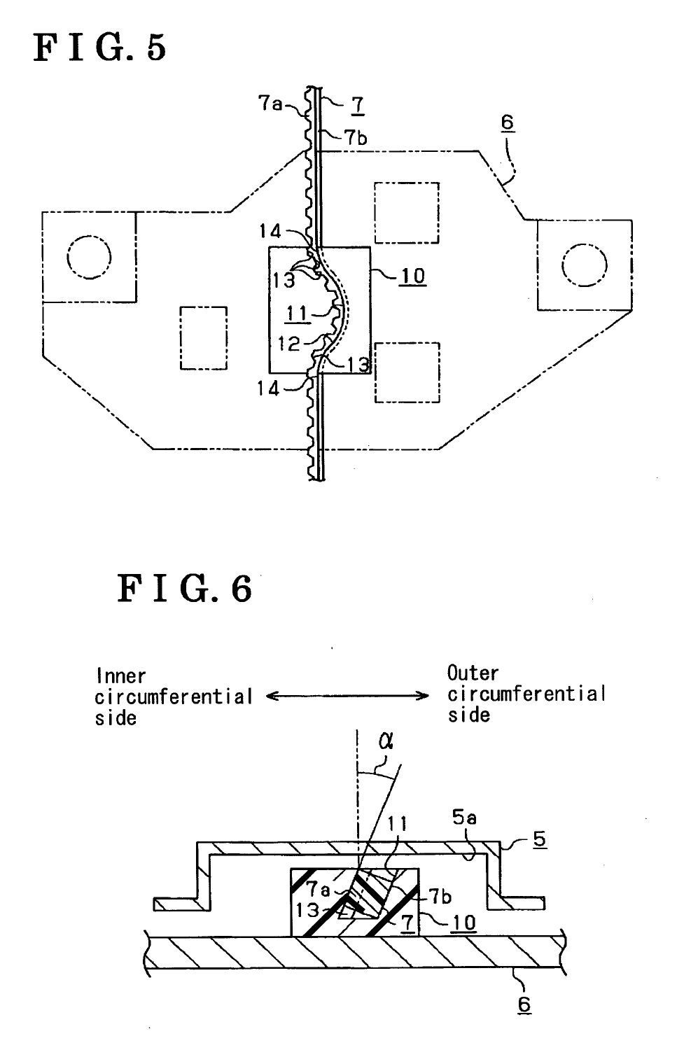

The belt-fixing portion 10 is made of resin. As illustrated in FIG. 5, the belt-fixing portion 10 includes a fixing groove 11 to which the timing belt 7 is inserted. A curved portion 12, which curves relative to a sliding direction of the carrier 6 (vertical direction in FIG. 5), is formed at a middle portion of the fixing groove 11 in a direction to which the fixing groove 11 extends. Linear portions 14, which extend along the sliding direction of the carrier 6, are formed at both ends of the fixing groove 11. The curved portion 12 is formed so as to curve out toward an outer circumferential side of the timing belt 7. Accordingly, the timing belt 7 is guided by the curved portion 12 of the fixing groove 11 so that a longitudinal direction of the timing belt 7 is different from a driving direction of the timing belt 7. Then, the timing belt 7 is guided by the linear portions 14 so that the longitudinal direction of the timing belt 7 extending from both sides of the fixing groove 11 is the same as the sliding direction of the carrier 6.

In two wall surfaces which form the fixing groove 11, a teeth portion 13, which engages with the teeth portion 7a of the timing belt 7, is formed at a wall surface inside the curved portion 12 and opposite of an outward direction of curving of the curved portion 12. The timing belt 7 engages with the teeth portion 13 in the longitudinal direction. Accordingly, a movement of the timing belt 7 relative to the belt-fixing portion 10 can be restricted.

Further, as illustrated in FIG. 6, the fixing groove 11 inclines relative to a direction vertical to an outer surface 5a of the guiding rail 5 by an inclination angle α. The teeth portion 7a of the timing belt 7 is guided so that the teeth portion 7a of the timing belt 7 is provided at the guiding rail 5 side. In other words, the fixing groove 11 has a function of an inclination guiding means (inclination limiting means) for limiting an inclination of the timing belt 7. Because the timing belt 7 is driven by the actuator 8 (refer to FIG. 1), the carrier 6 moves between both pulleys 9a and 9b along the guiding rail 5.

As illustrated in FIG. 3, the actuator 8 includes a holder 20 and a cover 21, which serves as a cover member and which is fixed to the holder 20 in an attachable/detachable way. The actuator 8 is fixed to the inner panel 2a (refer to FIG. 1). Further, an output gear 22, which serves as a rotational driving member, and a guiding shoe 23, which serves as a moving member, are provided between the holder 20 and the cover 21.

The output gear 22 is fixed to an output shaft 22a. The output shaft 22a is rotationally driven by a motor 24 (refer to FIG. 1) through a reduction mechanism (not illustrated). Further, the timing belt 7 engages with a teeth portion formed at an outer periphery of the output gear 22.

As illustrated in FIG. 4, the holder 20 includes an arc shape wall 20a provided at an outer side in a diametrical direction of the output gear 22 and formed to have an arc shape coaxial with the output gear 22. The arc shape wall 20a includes an inner surface 20b, which faces an outer circumferential surface 22b of the output gear 22. The guiding shoe 23 is provided between the inner surface 20b and the timing belt 7 strapped along the outer periphery of the output gear 22. The guiding shoe 23 is made of metal. It is also possible for the guiding shoe 23 to be made of resin. The guiding shoe 23 is formed to have an arc shape having a curvature along the back surface 7b of the timing belt 7, which engages with the output gear 22. A sliding surface 23a of the guiding shoe 23 slides along the back surface 7b of the timing belt 7. The sliding surface 23a is formed to have an arc shape coaxial with the output gear 22. Accordingly, the timing belt 7 provided between the guiding shoe 23 and the output gear 22 is guided by the sliding surface 23a of the guiding shoe 23 and engages with the output gear 22. A length of the guiding shoe 23 along a circumferential direction is defined between lines of angle θ1, which connect a rotational center O of the output gear 22 and both ends of the guiding shoe 23. The angle θ1 is larger than angle θ2 defined by lines, which connect the rotational center O of the output gear 22 and both ends of the arc shape wall 20a. The angle θ1 is larger than an angle θ3 defined by a line, which extends from the rotational center O of the output gear 22 to a point B, at which a circumscribing tangential line T1, which circumscribes the output gear 22 and the pulley 9a, touches the output gear 22, and a line, which extends from the rotational center O of the output gear 22 to a point C, at which a circumscribing tangential line T2, which circumscribes the output gear 22 and the pulley 9b, touches the output gear 22. Accordingly, the guiding shoe 23 crosses the circumscribing tangential line T1 of the first pulley 9a and the output gear 22 and crosses the circumscribing tangential line T2 of the second pulley 9b and the output gear 22. Therefore, a length L of an engaging portion (engaging length) of the timing belt 7 with the output gear 22 is longer than a length L1 of an engaging portion (engaging length) of the timing belt 7 with the output gear 22 at the time when the guiding shoe 23 is not utilized. Each end of the guiding shoe 23 is formed so as to have a curved surface. A movement of the guiding shoe 23 in a diametrical direction is restricted by the holder 20 and a movement of the guiding shoe 23 in an axial direction is restricted by the cover 21. In other words, the guiding shoe 23 is movable between the inner surface 20b of the holder 20 and the timing belt 7 along a circumferential direction.

The holder 20 is set so that the holder 20 does not contact the timing belt 7 at the time when the timing belt 7 is pulled and the timing belt 7 is placed on the circumscribing tangential line of the pulleys 9a and 9b and the output gear 22. Bolt holes 25a and 25b are formed at the holder 20. The cover 21 is fixed to the holder 20 by bolts 21a and 21b through the bolt holes 25a and 25b.

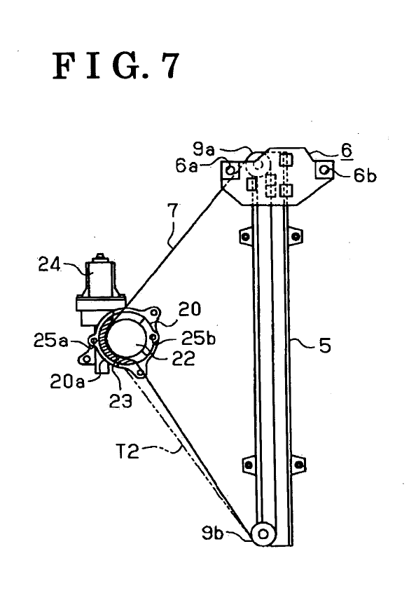

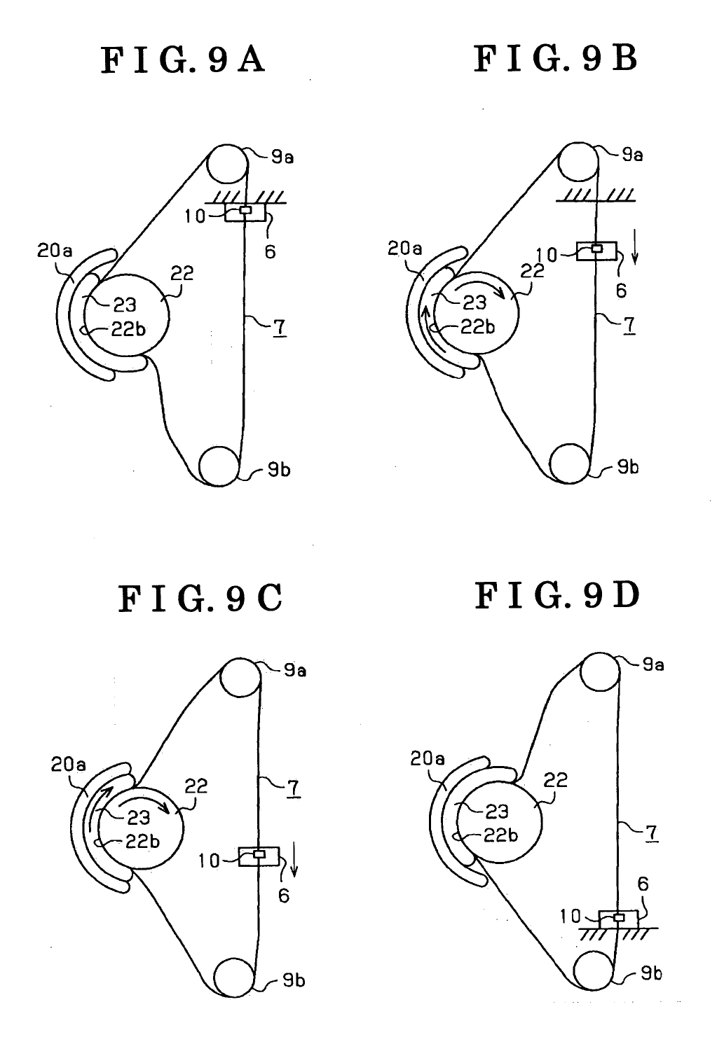

Next, actions of the window regulator 4 according to the embodiment of the present invention will be explained. At first, at the time when the window glass 3 is positioned at an entirely closed position (refer to FIG. 7), the carrier 6 is provided at an upper end portion of the guiding rail 5. At this time, as illustrated in FIG. 9A, the timing belt 7 between the output gear 22 and the first pulley 9a is in a tightened state and the timing belt 7 between the output gear 22 and the second pulley 9b is in a loosened state. The guiding shoe 23 is provided at the second pulley 9b side because the timing belt 7 between the output gear 22 and the first pulley 9a is pulled, and the guiding shoe 23 pushes the timing belt 7 between the output gear 22 and the pulley 9b to the inner circumferential side of the timing belt 7. As described above, the length L of the engaging portion (engaging length) of the timing belt 7 with the output gear 22 at this time is longer than the length L1 of the engaging portion (engaging length) of the timing belt 7 with the output gear 22 at the time when the guiding shoe 23 is not utilized (refer to FIG. 4).

When the window glass 3 starts descending from the entirely closed position (refer to FIG. 7), as illustrated in FIG. 9B, the timing belt 7 rotates clockwise when the output gear 22 rotates. The guiding shoe 23 is moved toward the first pulley 9a side at an outer side of the timing belt 7 in a diametrical direction along the outer circumferential surface 22b of the output gear 22 by sliding friction between the guiding shoe 23 and the timing belt 7. Thus, the guiding shoe 23 pushes the timing belt 7 between the output gear 22 and the first pulley 9a along the outer periphery of the output gear 22 toward the inner circumferential side of the timing belt 7. At this time, a position of an end portion of the engaging portion of the timing belt 7 at the first pulley 9a side with the output gear 22 becomes closer to the first pulley 9a. In the meantime, while the window glass 3 is descending, as illustrated in FIG. 9C, the timing belt 7 between the output gear 22 and the second pulley 9b is pulled toward the output gear 22 side by the rotation of the output gear 22, and the timing belt 7 between the output gear 22 and the first pulley 9a is rotationally moved from the output gear 22. Accordingly, because the timing belt 7 between the first pulley 9a and the output gear 22 is loosened, the timing belt 7 can be driven without receiving strong load from the guiding shoe 23.

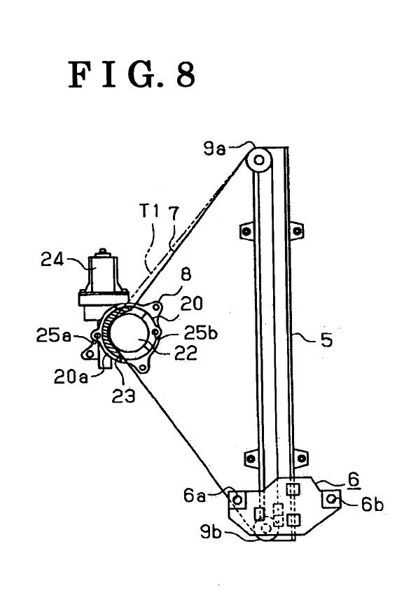

When the window glass 3 reaches an entirely opened position (refer to FIG. 8), the carrier 6 stops at a lower end portion of the guiding rail 5. Then, as illustrated in FIG. 9D, the timing belt 7 between the second pulley 9b and the output gear 22 is pulled because the carrier 6 stops. The guiding shoe 23 is pushed by the timing belt 7 between the second pulley 9b and the output gear 22 and is moved toward the first pulley 9a side. Accordingly, the timing belt 7, which extends from the output gear 22 to the first pulley 9a, is pushed by the guiding shoe 23 toward the inner circumferential side of the timing belt 7 along the outer periphery of the output gear 22, and looseness of the timing belt 7, between the output gear 22 and the first pulley 9a, is reduced.

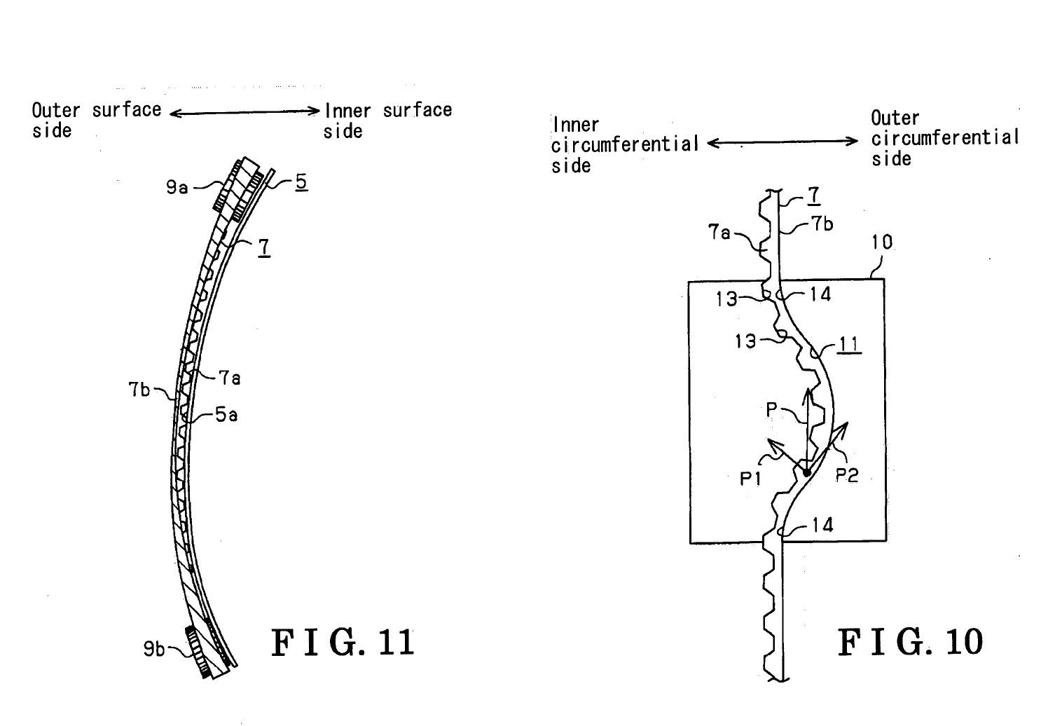

Next, actions of the carrier 6 according to the embodiment of the present invention will be explained. As described above, the timing belt 7 according to the embodiment is accommodated in the fixing groove 11 provided at the belt-fixing portion 10 of the carrier 6. As illustrated in FIG. 5 and FIG. 10, the fixing groove 11 includes the curved portion 12 formed so as to curve out toward the outer circumferential side of the timing belt 7. Accordingly, as illustrated in FIG. 10, force P1, which is applied in a direction that the teeth portion 7a is compressed, is generated at the curved portion 12, and tensile force P applied to the timing belt 7 is dispersed. Therefore, because shearing force P2 applied to the teeth portion 7a of the timing belt 7 can be reduced, a tooth surface of the teeth portion 7a of the timing belt 7 can be smaller. Further, because the fixing groove 11 includes the curved portion 12, a contacting area between the timing belt 7 and an inner wall of the fixing groove 11 increases. Therefore, the carrier 6 can be downsized, which can contribute to downsize the apparatus.

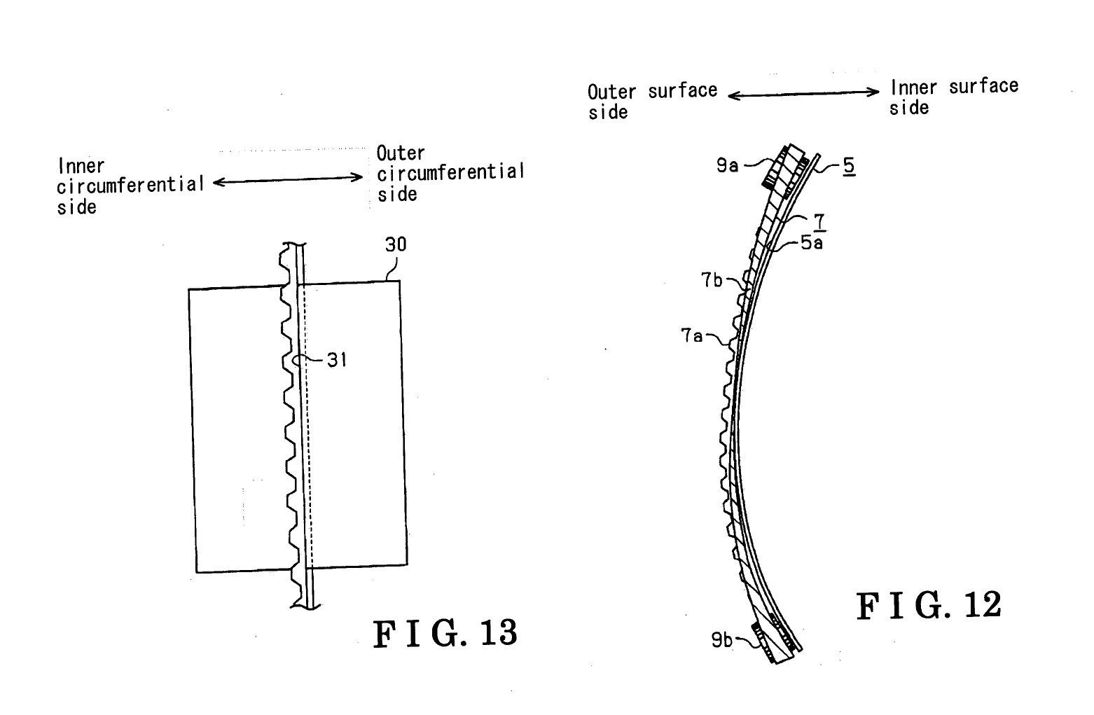

As illustrated in FIG. 2, the guiding rail 5 curves out toward the outer surface side. Accordingly, as illustrated in FIG. 12, there is a hazard that the belt-shaped timing belt 7, which is strapped along the pulleys 9a and 9b, twists, the back surface 7b of the timing belt 7 faces the guiding rail 5 side and the back surface 7b of the timing belt 7, of which wear resistance is lower than that of the teeth portion 7a, contacts the guiding rail 5. As described above, in the window regulator 4 according to the embodiment, the fixing groove 11 of the belt-fixing portion 10 is inclined relative to a direction vertical to the outer surface 5a of the guiding rail 5 by the inclination angle α. Accordingly, as illustrated in FIG. 11, the timing belt 7 can be guided so that the teeth portion 7a of the timing belt 7 is provided at the guiding rail 5 side and contact of the back surface 7b, of which wear resistance is inferior to that of the teeth portion 7a, with the guiding rail 5 can be inhibited.

As described above, according to the embodiment of the present invention, following effects can be obtained.

(1) Because the guiding shoe 23 is pushed by the timing belt 7 between the output gear 22 and the second pulley 9b and is moved between the arc shape wall 20a and the output gear 22 along a circumferential direction toward the first pulley 9a side, the timing belt 7, which extends from the output gear 22 to the first pulley 9a, is pushed to the inner circumferential side of the timing belt 7 along the periphery of the output gear 22. Accordingly, even in a situation where the timing belt 7 is elongated by the tensile load applied to the timing belt 7, the looseness of the timing belt 7, which extends from the output gear 22 to the first pulley 9a, can be reduced, detachment of the timing belt 7 from the output gear 22 (rotor) can be inhibited and the window regulator 4, which can preferably operate in a long term, can be obtained. Further, because the looseness of the timing belt 7 is reduced, displacement of the timing belt 7 to a direction vertical to the driving direction of the timing belt 7 can be restricted. Accordingly, rapid deterioration of the timing belt 7 caused by contact with another member can be prevented and a window regulator, which can preferably operate in a long term, can be obtained.

(2) Because the cover 21, which restricts a movement of the guiding shoe 23 in an axial direction, is attachable/detachable to/from the holder 20, the guiding shoe 23 can be easily assembled with the output gear 22 from the axial direction side.

(3) Because the timing belt 7 is guided by the fixing groove 11 so that the longitudinal direction of the timing belt 7 is different from the driving direction of the timing belt 7, force applied to the timing belt 7 along the longitudinal direction of the timing belt 7 can be dispersed. Accordingly, tensile strength applied to the timing belt 7 can be reduced. Further, according to the configuration described above, a contacting area between the timing belt 7 and the fixing groove increases in comparison with a situation where the longitudinal direction of the timing belt 7 corresponds to the driving direction of the timing belt 7, which can contribute to downsize the carrier.

(4) Because the timing belt 7 is guided by the fixing groove 11 so that the longitudinal direction of the timing belt 7 is different from the driving direction of the timing belt 7, shearing force applied to the teeth portion 7a of the timing belt 7 along the longitudinal direction of the timing belt 7 can be dispersed. Accordingly, because load applied to the teeth portion 7a of the timing belt 7 is reduced, the tooth surface of the teeth portion 7a fixed to the belt-fixing portion 10 can be smaller, which can contribute to downsize the carrier 6.

(5) Because the curved portion 12 is formed so as to curve out toward the outer circumferential side of the timing belt 7, the timing belt 7 is pulled and is biased to a direction of engagement of the teeth portion 7a of the timing belt 7 with the fixing groove 11. Accordingly, the timing belt 7 can reliably engage with the fixing groove 11.

(6) The inclination of the timing belt 7 can be arbitrarily set by the fixing groove 11. Accordingly, the timing belt 7 can be inclined so that the teeth portion 7a of the timing belt 7, of which wear resistance is superior in the timing belt 7, is provided at the guiding rail 5 side. Therefore, rapid deterioration of the back surface 7b, of which wear resistance is inferior to that of the teeth portion 7a, caused by contact with the guiding rail 5, can be inhibited.

(7) Because the sliding surface 23a of the guiding shoe 23 is formed so that the sliding surface 23a of the guiding shoe 23 is strapped along the back surface 7b of the timing belt 7 at the time when the timing belt 7 is provided along the output gear 22, the timing belt 7 can reliably engage with the output gear 22. Accordingly, because occurrence of sliding between the timing belt 7 and the output gear 22 can be inhibited, a timing belt 7, which has a small tooth surface, can be utilized. Further, a length of the guiding shoe 23 along a circumferential direction, which is defined between the lines of angle θ1, is larger than the angle θ3 defined by the line, which extends from the rotational center O of the output gear 22 to the point B, at which the circumscribing tangential line T1, which circumscribes the output gear 22 and the pulley 9a, touches the output gear 22, and the line, which extends from the rotational center O of the output gear 22 to the point C, at which the circumscribing tangential line T2, which circumscribes the output gear 22 and the pulley 9b, touches the output gear 22 (refer to FIG. 4). Accordingly, the length L of the engaging portion (engaging length) of the timing belt 7 with the output gear 22 can be longer than the length L1 of the engaging portion (engaging length) of the timing belt 7 and the output gear 22 at the time when the guiding shoe 23 is not utilized. In the meantime, the length of the engaging portion of the timing belt 7 with the output gear 22 is longest in a situation where the guiding shoe 23 is present at the first pulley 9a side or the second pulley 9b side, in other words, the carrier 6 is present at the entirely closed position or the entirely opened position of the window glass 3. Accordingly, the number of engaging teeth of the timing belt 7 with the output gear 22 can increase at the time of starting a movement of the window glass 3 and the timing belt 7 can be reliably driven.

(8) Because the guiding shoe 23 is moved according to a pulled state of the timing belt 7 between the output gear 22 and the pulleys 9a and 9b, load applied to the timing belt 7 can be reduced in comparison with a configuration, in which the timing belt is biased with use of a spring, or the like, to a direction that the looseness of the timing belt 7 is restricted.

(9) Because the guiding shoe 23 is supported by the holder 20, shafts for supporting the guiding shoe 23 and a spring for biasing the guiding shoe 23, or the like, are not necessary. Accordingly, increase in the number of parts can be inhibited and assembling work can be simple.

In the meantime, the embodiment of the present invention can be changed as follows. In the embodiment described above, the timing belt 7 is utilized as the driven member. However, it is not limited. For example, wires or resin tapes can be also utilized as the driven member.

In the embodiment described above, the fixing groove 11 of the belt-fixing portion 10 includes the curved portion 12. However, it is not limited. For example, it is also possible that a fixing portion 31 of a belt-fixing portion 30 is configured only from a linear portion, which extends along the sliding direction of the carrier 6 as illustrated in FIG. 13.

In the embodiment described above, the curved portion 12, which curves relative to the sliding direction of the carrier 6, is provided at the fixing groove 11. However, any configuration can be employed if the fixing groove 11 guides the timing belt 7 so that the longitudinal direction of the timing belt 7 is different from the driving direction of the timing belt 7. For example, a configuration, in which the fixing groove 11 is inclined relative to the driving direction of the carrier 6, can be employed.

In the embodiment described above, a movement of the guiding shoe 23 in an axial direction is restricted by the cover 21. However, it is not limited. Any configuration change can be made appropriately if a movement of the guiding shoe 23, in a diametrical direction and in an axial direction, can be restricted in the configuration. For example, a configuration, in which a movement of the guiding shoe in an axial direction is restricted by a groove formed on an outer circumferential surface of the guiding shoe and a guiding protruding portion provided on an inner surface of the arc shape wall 20a along a circumferential direction, can be employed.

In the embodiment described above, the fixing groove 11 has a function of the inclination limiting means. However, it is not limited. It is also possible that other members, which have a function of the inclination limiting means, are provided at both end portions of the fixing groove 11. Further, if the fixing groove 11 does not serve as the inclination limiting means and is not inclined relative to a direction vertical to the outer side surface 5a of the guiding rail 5 by the inclined angle α, effects (1) to (5) and (7) to (9) can be obtained.

In the embodiment described above, the inner surface 20b is configured from the arc shape wall 20a formed to be an arc shape coaxial with the rotational driving member (output gear 22). However, it is not limited. For example, inner surfaces of plural members, which are provided in an arc shape coaxial with the output shaft and which can restrict a movement of the guiding shoe 23 in a diametrical direction and can guide a movement thereof in a circumferential direction, can be employed.

In the embodiment described above, the belt-fixing portion 10 was made of resin. However, a material of the belt-fixing portion 10 can be appropriately changed, for example, to metal, or the like.

According to a first aspect of the present invention, an apparatus for moving a window glass of a vehicle includes a carrier fixed to a window glass, a guiding rail for slidably supporting the carrier, a driven member fixed to the carrier and an actuator for driving the driven member to move the window glass along the guiding rail. The actuator includes a rotational driving member formed in a cylindrical shape and rotated for driving the driven member, a holder provided at an outside of the rotational driving member in a diametrical direction and having an inner surface facing an outer circumferential surface of the rotational driving member, the inner surface being an arc shape coaxial with the rotational driving member, and an arc-shaped moving member having a circumferential length longer than a circumferential length of the inner surface of the holder, the moving member being provided between the rotational driving member and the inner surface of the holder for circumferential movement by the driven member.

According to the first aspect, the moving member is pushed by the driven member provided between the rotational driving member and a first pulley. Then, the moving member moves between the rotational driving member and the inner surface of the holder along a circumferential direction toward a second pulley. Thus, the driven member, which extends from the rotational driving member to the second pulley, is pushed along an outer periphery of the rotational driving member toward an inner circumferential side of the driven member. Accordingly, even in a situation where the driven member is elongated by tensile load applied to the driven member, looseness of the driven member, which extends from the rotational driving member to the second pulley, can be reduced and detachment of the driven member from the rotational driving member (rotor) can be inhibited. Accordingly, an apparatus for moving a window glass of a vehicle that can preferably operate in a long term can be obtained.

According to a second aspect of the present invention, in the apparatus for moving the window glass of the vehicle according to the first aspect, the actuator includes a cover member fixed to the holder in an attachable/detachable way for restricting a movement of the moving member in an axial direction.

According to the second aspect, because a movement of the moving member toward an axial direction is restricted by the cover member which is attachable/detachable, the moving member is guided to move in a circumferential direction by the holder and the cover member. Further, because the cover member is fixed to the holder in the attachable/detachable way, the moving member can be easily assembled with the rotational driving member from an axial direction side.

According to a third aspect of the present invention, an apparatus for moving a window glass of a vehicle includes a carrier fixed to a window glass, a guiding rail for slidably supporting the carrier, a driven member fixed to the carrier and an actuator for driving the driven member to move the window glass along the guiding rail. The carrier includes a fixing groove for fixing the driven member and for guiding the driven member so that a longitudinal direction of the driven member is different from a driving direction of the driven member.

According to the third aspect, because the driven member is guided by the fixing groove so that the longitudinal direction of the driven member is different from the driving direction of the driven member, force applied to the driven member along the longitudinal direction of the driven member can be dispersed. Accordingly, tensile force applied to the driven member can be reduced and an apparatus for moving a window glass of a vehicle, which can preferably operate in a long term, can be obtained. Further, because a contact surface between the driven member and the fixing groove increases in comparison with a situation where the longitudinal direction of the driven member corresponds to the driving direction of the driven member, the carrier can be downsized.

According to a fourth aspect of the present invention, in the apparatus for moving the window glass of the vehicle according to the third aspect, the driven member includes an engaging portion for engaging with the fixing groove along the longitudinal direction of the driven member.

According to the fourth aspect, because the driven member is guided by the fixing groove so that the longitudinal direction of the driven member is different from the driving direction of the driven member, shearing force applied to the engaging portion of the driven member along the longitudinal direction of the driven member can be dispersed. Accordingly, load applied to the engaging portion of the driven member can be reduced and an apparatus for moving a window glass of a vehicle that can preferably operate in a long term can be obtained.

According to a fifth aspect of the present invention, in the apparatus for moving the window glass of the vehicle according to the fourth aspect, the engaging portion is provided at an inner circumferential side of the driven member and the fixing groove includes a curved portion curving out toward an outer circumferential side of the driven member relative to a sliding direction of the carrier.

According to the fifth aspect, because the driven member is pulled and is biased to an engaging direction of the engaging portion of the driven member with the fixing portion, the driven member can be reliably engaged.

According to a sixth aspect of the present invention, an apparatus for moving a window glass of a vehicle includes a carrier fixed to a window glass, a guiding rail for slidably supporting the carrier, a driven member fixed to the carrier and an actuator for driving the driven member to move the window glass along the guiding rail. The actuator includes a rotational driving member formed in a cylindrical shape and rotated for driving the driven member, a holder provided at an outside of the rotational driving member in a diametrical direction and having an inner surface facing an outer circumferential surface of the rotational driving member, the inner surface being an arc shape coaxial with the rotational driving member, and an arc-shaped moving member having a circumferential length longer than a circumferential length of the inner surface of the holder, the moving member being provided between the rotational driving member and the inner surface of the holder for circumferential movement by the driven member. The carrier includes a fixing groove for fixing the driven member and for guiding the driven member so that a longitudinal direction of the driven member is different from a driving direction of the driven member.

According to the sixth aspect, the moving member is pushed by the driven member provided between the rotational driving member and a first pulley. Accordingly, the moving member moves between the rotational driving member and the inner surface of the holder along a circumferential direction toward a second pulley. Thus, the driven member, which extends from the rotational driving member to the second pulley, is pushed toward an inner circumferential side of the driven member along an outer periphery of the rotational driving member. Accordingly, even in a situation where the driven member is elongated by tensile load applied to the driven member, looseness of the driven member, which extends from the rotational driving member to the second pulley can be reduced and detachment of the driven member from the rotational driving member (rotor) can be inhibited and an apparatus for moving a window glass of a vehicle that can preferably operate in a long term can be obtained. Further, because the driven member is guided by the fixing groove so that the longitudinal direction of the driven member is different from the driving direction of the driven member, force applied to the driven member along the longitudinal direction of the driven member can be dispersed. Accordingly, tensile force and shearing force applied to the driven member can be reduced and an apparatus for moving a window glass of a vehicle that can preferably operate in a long term can be obtained.

According to a seventh aspect of the present invention, an apparatus for moving a window glass of a vehicle includes a carrier fixed to a window glass, a guiding rail for slidably supporting the carrier, a driven member fixed to the carrier and an actuator for driving the driven member to move the window glass along the guiding rail. The apparatus for moving the window glass of the vehicle further includes pulleys provided at the guiding rail for supporting the driven member thereon and an inclination limiting means for limiting an inclination of a belt serving as the driven member provided between the pulleys with an inclination relative to the guiding rail. The guiding rail curves out toward a direction in which the pulleys are provided and the guiding rail is curved with a curvature corresponding to a curvature of the window glass.

According to the seventh aspect, the inclination of the belt relative to the guiding rail can be arbitrarily set by the inclination limiting means. Accordingly, the belt can be inclined so that a part of the belt, which is superior in wear resistance, can be provided at the guiding rail side and rapid deterioration of the belt can be inhibited.

According to each aspect of the present invention, an apparatus for moving a window glass of a vehicle that can preferably operate in a long term can be provided.

The principles, preferred embodiment and mode of operation of the present invention, have been described in the foregoing specification. However, the invention that is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. An apparatus for moving a window glass of a vehicle, comprising:
a carrier fixed to a window glass;
a guiding rail for slidably supporting the carrier;
a driven member fixed to the carrier; and
an actuator for driving the driven member to move the window glass along the guiding rail, wherein
the actuator comprises a rotational driving member formed in a cylindrical shape and rotated for driving the driven member, a holder provided at an outside of the rotational driving member in a diametrical direction and having an inner surface facing an outer circumferential surface of the rotational driving member, the inner surface being an arc shape coaxial with the rotational driving member, and an arc-shaped moving member having a circumferential length longer than a circumferential length of the inner surface of the holder, the moving member being provided between the rotational driving member and the inner surface of the holder for circumferential movement by the driven member.

2. The apparatus for moving the window glass of the vehicle according to claim 1, wherein
the actuator comprises a cover member fixed to the holder in an attachable/detachable way for restricting a movement of the moving member in an axial direction.

3. The apparatus for moving the window glass of the vehicle according to claim 1, wherein
the carrier comprises a fixing groove for fixing the driven member and for guiding the driven member so that a longitudinal direction of the driven member is different from a driving direction of the driven member.

4. The apparatus for moving the window glass of the vehicle according to claim 3, wherein
the driven member comprises an engaging portion for engaging with the fixing groove along the longitudinal direction of the driven member.

5. The apparatus for moving the window glass of the vehicle according to claim 4, wherein
the engaging portion is provided at an inner circumferential side of the driven member and the fixing groove comprises a curved portion curving out toward an outer circumferential side of the driven member relative to a sliding direction of the carrier.

6. The apparatus for moving the window glass of the vehicle according to claim 1, further comprising:
pulleys provided at the guiding rail for supporting the driven member thereon; and
an inclination limiting means for limiting an inclination of a belt serving as the driven member provided between the pulleys with an inclination relative to the guiding rail, wherein
the guiding rail curves out toward a direction in which the pulleys are provided and the guiding rail is curved with a curvature corresponding to a curvature of the window glass.

7. The apparatus for moving the window glass of the vehicle according to claim 1, further comprising:
pulleys provided at the guiding rail for supporting the driven member thereon, wherein the carrier comprises a fixing groove for fixing the driven member and for guiding the driven member so that a longitudinal direction of the driven member is different from a driving direction of the driven member, the guiding rail curves out toward a direction in which the pulleys are provided, the guiding rail is curved with a curvature corresponding to a curvature of the window glass and the apparatus for moving the window glass of the vehicle further comprises an inclination limiting means for limiting an inclination of a belt serving as the driven member provided between the pulleys with an inclination relative to the guiding rail.

8. The apparatus for moving the window glass of the vehicle according to claim 7, wherein
the actuator includes a cover member fixed to the holder in an attachable/detachable way for restricting a movement of the moving member in an axial direction.

9. The apparatus for moving the window glass of the vehicle according to claim 7, wherein
an engaging portion is provided at an inner circumferential side of the driven member and the fixing groove comprises a curved portion curving out toward an outer circumferential side of the driven member relative to a sliding direction of the carrier.

10. A window glass guiding apparatus for use with a vehicle having a body in which a window glass is guided for vertical movement between raised and lowered positions, comprising:
a guiding rail for fixing within the body;
a carrier fixed to the window glass and slidably mounted on the guiding rail;
an operating member connected to the carrier; and
an actuator for driving the operating member to slide the window glass along the guiding rail, the actuator including a rotational driving member formed into a generally cylindrical shape having an outer surface, the rotational driving member when being rotated causing the operating member to move, a holder having an arc-shaped inner surface, the holder being placed at a position such that the arc-shaped inner surface of the holder is spaced apart from the outer surface of the rotational driving member to have a same curvature as therewith, and a moving member formed into an arc-shaped configuration to have a circumferential length which is larger than that of the arc-shaped inner surface of the holder, the moving member being provided between the arc-shaped inner surface of the holder and the outer surface of the rotational driving member for movement by the operating member.
